(19) United States
(12) Patent Application Publication
(10) Pub. No.: US 2007/0146135 A1
(43) Pub. Date: Jun. 28, 2007

(54) Assembling RFID components using webs

(76) Inventors: David Boyadjieff, Temecula, CA (US); Daniel C. Finn, Valley Center, CA (US); George M. Wohlhieter, Escondido, CA (US)

Correspondence Address: Terrance A. Meador;INCAPLAW, Suite K, 1050 Rosecrans Street, San Diego, CA, 92106, US

(21) Appl. No.: 11/318,792

(22) Filed: Dec. 27, 2005

(51) Int. Cl. G08B 13/14

(52) U.S. Cl. 340/572.1; 705/22

(57) ABSTRACT

Webs carrying RFID antennas RFID modules support high-speed mass production of RFID tags. Preferably, a sprocketed web having a sequence of sprocket holes near at least one margin to be engaged by a sprocket drive in a machine carries a sequence of RFID antennas, and another sprocketed web carries a sequence of RFID modules. Each web may be advanced past a forming station at which a module is separated from its web and attached to an antenna on the other web. The process produces a web of assembled and packaged RFID tags. Optionally, during the process, before RFID modules are attached to antennas, data may be written to each modules and then read and verified prior to the forming station in order to test each module. A module with data failing verification may be removed from the process without being attached to an antenna.

### BACKGROUND

The field includes assembly of radio frequency identification components for handling, storage, and supply to manufacturers and assemblers.

### DESCRIPTION OF THE RELATED ART

Radio frequency identification (RFID) concerns the storage and remote retrieval of data through the use of RFID tags, small transponder devices that can be attached to persons, animals, or objects. According to the on-line RFID Journal (URL address www.rfidjournal.com) an RFID tag is constituted of a microchip, a small piece of semi-conductive material containing miniaturized electronic circuits, attached to an antenna. The microchip may include memory and other electronic circuitry. The RFID tag operates in response to an electromagnetic field sensed by the antenna. When the electromagnetic field is sensed by the antenna, the RFID tag is stimulated to transmit data stored in its memory. Typically, the data includes information identifying, describing, and/or locating the object to which the RFID tag is attached.

RFID tags are typically manufactured by joining a microchip to an antenna by means of one or more contacts. The microchip may be connected to the contacts (or conductive pads) to form a module that is then attached to the antenna. Web processes have been employed to mass produce RFID tags. In this regard, a web is a roll of material that may be fed into a machine to enable or support the assembly of a product. For example, antennas may be formed on or in a web of substrate material. The web is brought against an anvil that attaches a module to each antenna as the web moves past the anvil. The process yields a web of assembled RFID tags that may be separated into individual RFID tags to be attached to objects by subsequent steps in the same process, or the web may be rolled and transported to another process or shipped to manufacturers or assemblers.

The focus of web applications to the manufacture of RFID tags has been on the mechanics of RFID tag assembly. As a consequence, the web manufacturing process has developed to emphasize one or another particular RFID tag construction. The speed, efficiency and reliability of the process itself have been overlooked in the drive to produce customized RFID tag configurations. Consequently, the industry is now faced with the problem of a proliferation of slow and expensive web processes for mass assembly and handling of assembled RFID tags.

### SUMMARY OF THE INVENTION

The problem is solved by provision of at least two webs useful for an apparatus and a method capable of speedily and inexpensively assembling RFID tags. One web carries a sequence of RFID antennas and another web carries a sequence of RFID modules. In some aspects, the webs may be sprocketed webs. In this regard, a “sprocketed web” is a web having a sequence of sprocket holes near at least one edge to be engaged by a sprocket drive. Each web may be engaged and advanced past a forming station at which a module is separated from its web and attached to an antenna on the other web. The method can produce a web of assembled and packaged RFID tags. Engagement between sprocketed webs and sprocketed drives may support high-speed movement of the webs under conditions of precise registration between very small RFID components. Optionally, before modules are attached to antennas, data may be written to a module and then read and verified prior to the forming station. A module with data failing verification may be removed from the process without being attached to an antenna, thereby enhancing the yield of the process. The cost of manufacturing the RFID tags is driven down by the high speed and high yield of the manufacturing process.

### BRIEF DESCRIPTION OF THE DRAWINGS

FIG. 1 is a schematic representation showing, in plan, the assembly of RFID components using webs.

FIGS. 2A-2C are schematic side sections of the webs illustrated in FIG. 1.

FIG. 3 is a magnified top plan view of an assembled RFID tag on a web.

FIG. 4 is a partially schematic elevation view of an apparatus for assembling and packing RFID tags using sprocketed webs.

FIG. 5A is a perspective view of a forming station in the apparatus of FIG. 4. A series of assembly steps performed at the forming station is shown in FIGS. 5B-5E which illustrate an enlarged portion of the forming station contained in the circle A in FIG. 5A.

FIG. 6 is a schematic plan view of an assembled RFID tag.

FIG. 7 is a schematic diagram illustrating a controller for the apparatus of FIG. 4.

FIG. 8 is a flow diagram illustrating a process for assembling and packing RFID tags using webs. FIG. 8A is a flow diagram illustrating a modification of the method of FIG. 8.

### DETAILED DESCRIPTION OF THE PREFERRED EMBODIMENTS

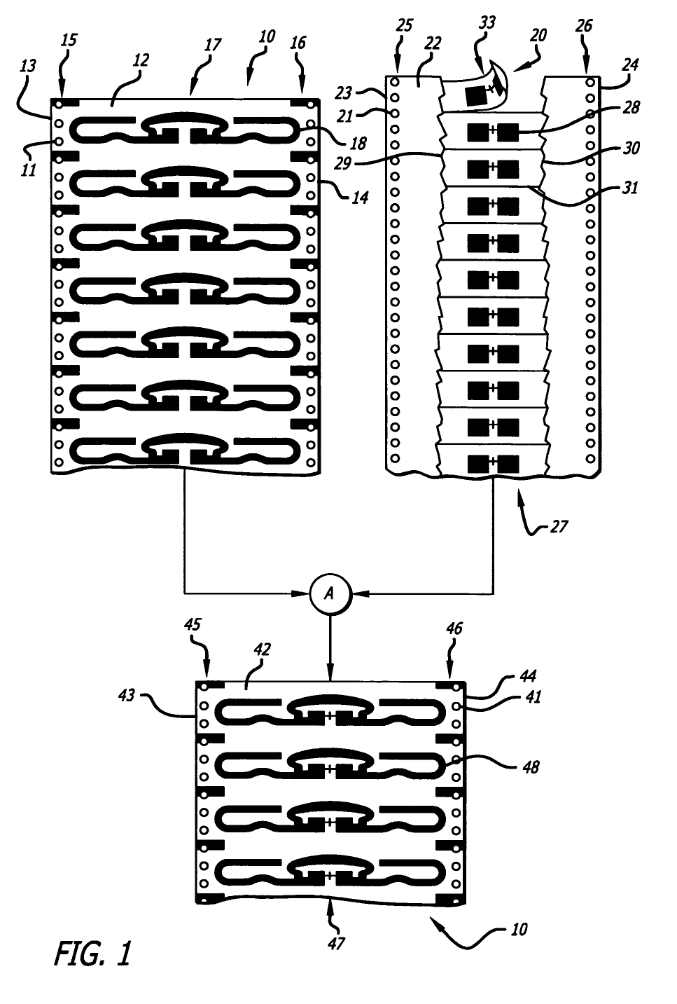

FIGS. 1, 2A-2C, and 3 illustrate assembly of RFID tags using webs, in which each web is constituted of an elongate strip of flexible substrate material carrying a sequence of RFID components. Each strip may be spooled for handling and use. Each web may be, for example, a sprocketed web with a sequence of sprocket holes near at least one edge to be engaged by a sprocket drive in a machine. One web 10 carries a sequence of RFID antennas (also called “antennas”) and another web 20 carries a sequence of RFID modules (also called “modules”). The webs 10 and 20 are engaged in an apparatus (described below and represented in FIG. 1 by A) and advanced thereby past a forming station of the apparatus at which a module is separated from its web 20 and attached to an antenna on the web 10. The process produces a web 40 of assembled RFID tags. Preferably, the web 40 is also a sprocketed web.

The web 10 is constituted of an elongate strip of substrate material 12 with opposing edges 13 and 14. In one aspect, at least one sequence 15 of sprocket holes is formed in the web 10 near the edge 13. One such sprocket hole is indicated by reference numeral 11. Preferably, another sequence 16 of sprocket holes is formed in the web 10 near the edge 14. An elongate sequence 17 of RFID antennas is disposed on one of the surfaces of the web 10; one of the antennas is indicated by reference numeral 18. The sequence 17 of RFID antennas is disposed between the edges 13 and 14, with the sequence 15 of sprocket holes disposed between the edge 13 and the sequence 17 of RFID antennas and the sequence 16 of sprocket holes disposed between the edge 14 and the sequence 17 of RFID antennas. This web 10 may be referred to as an “antenna web” later in this specification.

The web 20 is constituted of an elongate strip of substrate material 22 with opposing edges 23 and 24. In one aspect, at least one sequence 25 of sprocket holes is formed in the web 20 near the edge 23. One such sprocket hole is indicated by reference numeral 21. Preferably, another sequence 26 of sprocket holes is formed in the web 20 near the edge 24. An elongate sequence 27 of RFID modules is disposed on one of the surfaces of the web 20; one of the modules is indicated by reference numeral 28. The sequence 27 of RFID modules is disposed between the edges 23 and 24, with the sequence 25 of sprocket holes disposed between the edge 23 and the sequence 27 of RFID modules, and the sequence 26 of sprocket holes disposed between the edge 24 and the sequence 27 of RFID modules. An elongate perforation 29 is formed in the second web 20 between the sequence 27 of RFID modules and the sequence 25 of sprocket holes. Another elongate perforation 30 is formed in the second web 20 between the sequence 27 of RFID modules and the sequence 26 of sprocket holes. A plurality of perforations transverse to and extending between the elongate perforations 29 and 30 are formed in the web 20. One of these transverse perforations is indicated by reference numeral 31. The transverse perforations 31 are interlaced with the RFID modules 28 in a sequence characterized by the pattern:
. . . RFID module/transverse perforation/RFID module/transverse perforation . . .
   The elongate perforations 29 and 30, together with the transverse perforations 31, form a closed trace of perforations in the substrate material 22 around each RFID module 28, thereby enabling each module 28, with an attached strip of substrate material 22, to be separated from the web 20. For convenience, an RFID module 28 separated from the web 20 may be referred to as a “separated module”. One RFID module, indicated by reference numeral 33, is shown partly separated from the sprocketed web 20 in FIG. 1. This web 20 may be referred to as a “module web” later in this specification.

By an apparatus and method to be described, the webs 10 and 20 are fed in parallel to a forming station in A in FIG. 1, where an RFID module 28 may be separated from the web 20 and attached to a respective antenna 18 on the web 10 to provide an assembled RFID tag. As the webs 10 and 20 advance through the forming station, a sequence of assembled RFID tags is formed on the substrate material of the web 10. The result is production of the web 40 on which a sequence 47 of assembled RFID tags is provided. One assembled RFID tag is indicated by reference numeral 48. The web 40 is constituted of an elongate strip of substrate material 42 with opposing edges 43 and 44. In one aspect, at least one sequence 45 of sprocket holes is provided in the web 40 near the edge 43. One such sprocket hole is indicated by reference numeral 41. Preferably, another sequence 46 of sprocket holes is provided in the web 40 near the edge 44. The elongate sequence 47 of RFID tags is disposed on the web 40 between the edges 43 and 44, with the sequence 45 of sprocket holes disposed between the edge 43 and the sequence 47 of RFID tags and the sequence 46 of sprocket holes disposed between the edge 44 and the sequence 47 of RFID tags. This web 40 may be referred to as a “tag web” or a “product web” later in this specification.

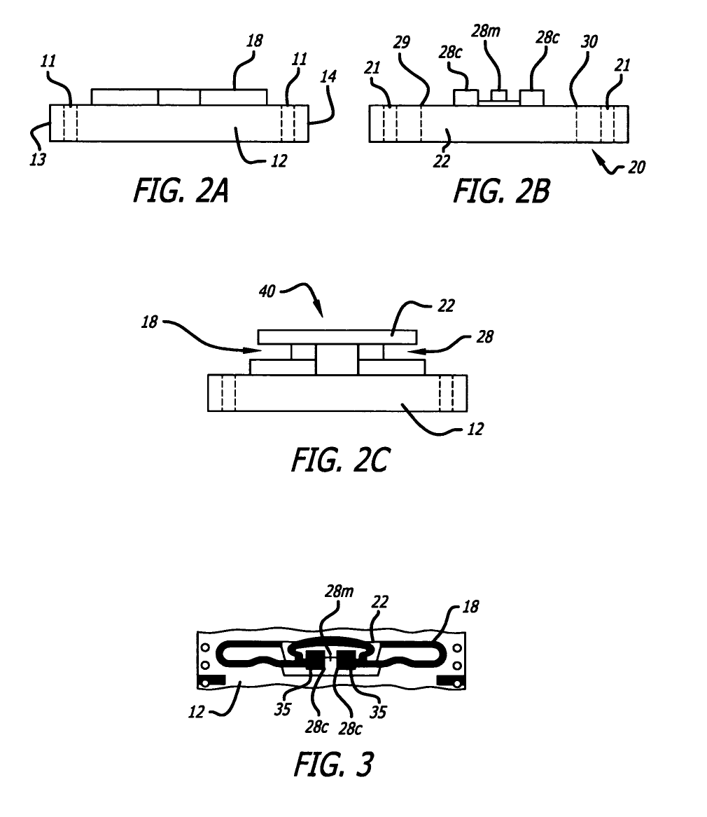

As suggested in FIGS. 2A-2C, the RFID components on the webs 10 and 20 have a preferred construction, although those constructions are not intended to limit the scope of this specification or of the claims which follow. Preferably, each of the webs 10 and 20 is constituted of a substrate, that is, a structure to support electronic or electrical elements, on which the RFID components (antennas and modules) are supported. The RFID components are preferably made of electrically conductive and semi-conductive materials. Preferably, for each web, the substrate is a web of flexible material suitable for supporting RFID components. For example, the web 10 may be constituted of a polyester film, on one surface of which a metal layer (copper, for example) is deposited. The RFID antennas may be formed in such a metal layer by selective removal of metal using a lithographic process. Sprocket holes may be formed in the web 10 by a high-precision punching process. Thus, as per FIG. 2A, the substrate material 12 of the web 10, with sprocket holes 11 formed therein, supports an antenna 18. Similarly, the web 20 may be constituted of a polyester film, on one surface of which a metal layer (copper, for example) is deposited. The contacts of the RFID modules may be formed in such a metal layer by selective removal of metal using a lithographic process. Following formation of the contacts, microchips are attached to the contacts using, for example, a vacuum-assisted anvil. Sprocket holes and perforations may be formed in the web 20 by high-precision punching and perforating processes. Thus, as per FIG. 2B, the substrate material 22 of the web 20, with sprocket holes 21 and perforations 29 and 30 formed therein, supports contacts 28c to which a microchip 28 m has been attached.

Representative specifications for the webs 10 and 20 are given in Table I. Webs manufactured according to these specifications have been used in the apparatus and method for assembling RFID tags described later. The specifications are provided for illustration only and are not intended to limit the specification or claims. The dimensions and other measurements in the table are nominal; tolerances may be specified as needed for a particular application. In the table, “pitch” refers to spacing between the identified elements. The pitch for (spacing between) RFID antennas varies from 12 mm to 76 mm in increments of 4 mm.

TABLE I

| | WEB 10 | WEB 20 |
|---|---|---|
| Substrate Material | Polyester | Polyester |
| RFID Antenna and | Copper | Copper |
| Contact Material | | |
| Width | 50 mm-200 mm | 40 mm |
| Thickness | 0.05 mm | 0.05 mm |
| Sprocket Hole Diameter | 1.5 mm | 1.5 mm |
| Sprocket Hole Indent | 2.0 mm | 2.0 mm |
| From Edge | | |
| Sprocket Hole Pitch | 4.0 mm | 4.0 mm |
| RFID Component Pitch | 12 mm-76 mm | 8.0 mm |

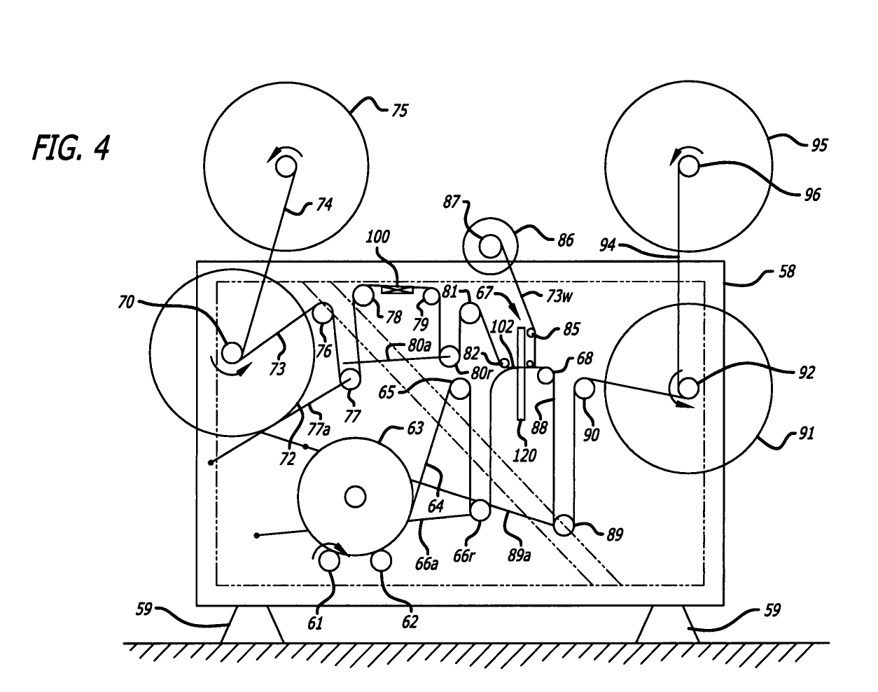

With reference still to FIGS. 2A-2C, depending on the relative orientations of the webs 10 and 20, on the web 40 an RFID module 28 may be attached directly to an antenna 18 to form an electrically continuous connection therewith (as per FIG. 2C). In this case, the strip of substrate material 22 in the separated RFID module 28 is disposed over the module, so that the antenna 18 and module 28 are disposed between the web material 12 and the strip of web material 22. Alternatively, with other relative orientations between the surfaces of the webs 10 and 20, one or more layers of substrate material 12, 22 may be sandwiched between the module 28 and antenna 18 to form an electrically capacitative connection therebetween. A magnified view of a portion of the web 40 illustrated in FIG. 2C is shown in FIG. 3. The top plan view of FIG. 3 shows a pattern of welds 35 by which a separated module is attached to an antenna on a web. Visible in this view are the web 12, the strip of substrate material 22, an antenna 18, and a module 28 including contacts 28c and a microchip 28m.

The teachings of this specification, and the claims, are not limited by the particular constructions of the sprocketed webs 10 and 20, nor by the particular constructions of the RFID components they carry. Many materials and constructions may be used for the webs and RFID components in implementing the principles set forth herein. See, for example, the many web and RFID materials and constructions described in U.S. Pat. No. 6,940,408. Without limitation, RFID components may be disposed on or in webs by various technological processes including formation, placement, and assembly. Thusl reference to RFID components “on a web” is intended to mean RFID components such as antennas or modules that are formed, placed, or otherwise assembled on or in a web, absent use of more specific language.

An exemplary web manufacturing apparatus for assembling and packaging RFID tags using webs may be understood with reference to FIG. 4. Preferably, the webs used are sprocketed webs. The apparatus 60 is for illustration and its layout and construction may be adapted in many ways to accommodate many design requirements. The apparatus 60 has a stainless steel mounting panel 58 that can be supported on a floor by feet 59. The mounting panel 58 has a generally vertically-disposed planar surface on and through which various fixed and moveable elements to be described may be mounted. A reel 63 is rotatably mounted on a motor-driven roller 61 and a roller 62. The reel 63 preferably includes a sprocketed antenna web 64 (which, when convenient, may also be referred to as “the web 64”) spooled thereonto. The web 64 may have the same construction as the web 10 of FIG. 1. The web 64 is unspooled when the roller 61 rotates in the direction indicated. The web 64 passes over a roller 65 and an idling roller 66r, through a forming station 67, and over a sprocketed drive 68. The idling roller 66r is mounted on an idling arm 66a. Because the web 64 is advanced through the apparatus 60 by the sprocketed drive 68, the path 63, 65, 66, 67, 68 followed by the web 64 is referred to as a “sprocket driven path”.

Referring still to FIG. 4, the apparatus 60 has a motor-driven feed hub 70 on which a reel 72 is rotatably mounted. A sprocketed module web 73 (which, when convenient, may also be referred to as “the web 73”) is spooled on the reel 72. The web 73 may have the same construction as the web 20 of FIG. 1. When the hub 70 is rotated in the direction indicated, the web 73 is unspooled from the reel and passes over a roller, an idling roller 77r, a roller 78, and a sprocketed drive 79. Following the sprocketed drive 79, the web 73 passes over idling roller 80r and a roller 81, under a sprocketed drive 82, and through the forming station 67. The idling rollers 77r and 80r are mounted on idling arms 77a and 80a. Out of the forming station 67, the web 73, with RFID modules removed therefrom, passes over a sprocketed drive 85 to a take-up reel 86 mounted on a motor-driven hub 87 that is rotated in the direction indicated by the arrow. Because the web 73 is advanced through the apparatus 60 by the sprocketed drives 79 and 82, the path 76, 77, 78, 79, 80, 81, 82, 67 is also referred to as a “sprocket driven path”. As is evident from FIG. 4, the sprocket-driven path 63, 65, 66, 67, 68 and the sprocket-driven path 76, 77, 78, 79, 80, 81, 82, 67 converge at the forming station 67. Because RFID modules are separated from the web 73 at the forming station 67, the module web, with any remaining RFID modules is essentially a waste web, as is indicated by reference numeral 73w in FIG. 4. Relatedly, the take-up reel 86 and the motor-driven hub 87 on which it is mounted constitute a waste station where the waste web 73w is reeled. Optionally, the web 73 may be spooled on the reel 72 with a buffer web 74 of soft, pliable material to protect the RFID modules on the web 73 during storage, shipment and handling. If used, such a buffer web may be taken up on a motor-driven reel 75 as the web 73 is unspooled.

RFID tags are assembled at the forming station 67 by separation of RFID modules from the web 73 and attachment of separated RFID modules to RFID antennas on the web 64. Out of the forming station 67, the web 64 becomes a sprocketed tag web (or “product web”) 88. The web 88 may have the same construction as the web 40 of FIG. 1. The product web 88 passes over idling roller 89r and roller 90 to a reel 91 that is mounted to a motor-driven hub 92. The idling roller 89r is mounted on an idling arm 89a. The reel 91 and hub 92 constitute a take-up station where the product web 88 is spooled when the hub 92 is rotated in the direction indicated by the arrow. The reel 91 with a product web 88 spooled thereon provides a convenient package for handling, storing, and shipping assembled RFID tags and for feeding them into other web-based manufacturing and/or assembly apparatus and processes. Optionally, the product web 88 may be spooled onto the reel 91 with a buffer web 94 of soft, pliable material to protect the RFID tags on the web 88 during storage, shipment and handling. If used, such a buffer web may be taken off a reel 95 mounted on a motor-driven hub 96 as the web 88 is spooled.

It may be useful to write data, information, and/or code (“data” for ease of expression) in the microchips of the RFID modules. Such a capability permits storage of information and/or initial programming, during RFID tag assembly, that may be useful to a method for assembling RFID tags, and that may possibly also be useful to the RFID tag function. For these purposes, a write station 100 may be provided in the sprocketed feed path of the web 73. In such a case, the sprocketed hub 79 would index movement of the web 73 with respect to the write station 100 as the web 73 advances past the write station 100. The write station 100 is for writing data into an RFID module in the web 73 as it passes the write station 100. With provision of a write station, it may also be useful to provide a read station to verify data written in the RFID modules as they advance, on the web 73, into the forming station. One possible use of the write/read sequence is to test the ability of modules to store data. A read station would enable the apparatus 60 to perform such a test and decide, based on verification of data written into each RFID module, whether to separate an RFID module from the web 73 and attach the RFID module to an antenna on the web 64 at the forming station if the data is verified, or to leave an RFID module on the waste web 73w while not attaching the RFID module to an antenna on the web 64 if the data is not verified. For these purposes, a read station 102 may be provided in the sprocketed feed path of the web 73, preferably immediately before the forming station 67. The read station 102 is for reading data, information and/or code in an RFID module in the web 73 as it passes the read station 102.

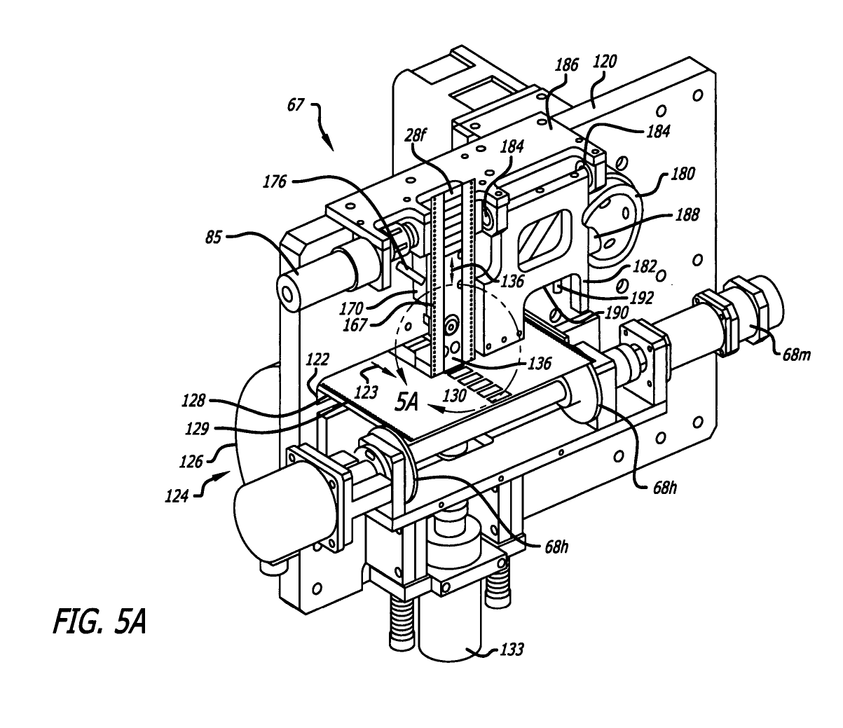

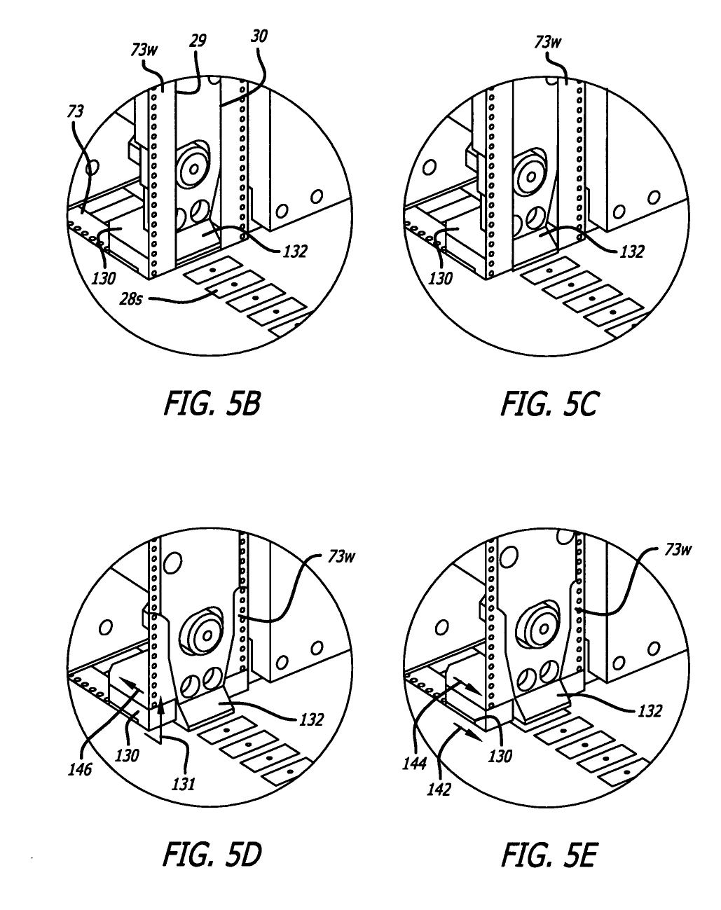

FIGS. 4 and FIGS. 5A-5E illustrate how RFID tags are assembled by a series of manufacturing steps performed on an antenna web and a module web that converge at the forming station 67. As best seen in FIGS. 4 and 5A, the forming station 67 has a wall 120 that is generally perpendicular to the plane of, and fixed to the panel 58 (not seen in this view) with an elongate transverse aperture 122. The aperture is also generally perpendicular to the plane of the panel 58. A feed ramp 124 also fixed to the panel 58 has an upwardly-curving rear section 126 that approaches the aperture 122 and transitions through the aperture 122 to a generally flat forward section 128. The section 128 has a generally planar surface 129 that is generally perpendicular to the fixed wall 120 and the plane of the panel 58. The web 64 is slidably received on the rear section 126 and travels thereon up to and along the planar surface 129 to the sprocketed drive 68 on which the web 64 is engaged. The sprocketed drive 68 advances the web 64 by a fixed amount each time the motor driving it is activated. The web 73 travels to and through the aperture 122, generally parallel to, in the same direction as, and with the web 64. The sprocketed drive 82 advances the web 73 by a fixed amount each time the motor driving it is activated. It is at the aperture 122 and along the planar surface 129 that the sprocket-driven paths on which the webs 64 and 73 travel, converge. In converging, the sprocket driven paths cause the webs 64 and 73 to converge and travel through the forming station 67 in an orientation in which the webs 64 and 73 are parallel, overlapping and longitudinally aligned. If either web is narrower than the other, the narrower web may be longitudinally positioned, or centered, between the edges of the wider web. Also, while the example to be described presumes that the surfaces of the webs 64 and 73 are oriented so that the RFID antennas face the RFID modules, it should be evident that other orientations of the web surfaces may be utilized.

Referring to FIGS. 4 and 5A, the webs 64 and 73 are aligned with each other and with elements of the forming station by the sprocketed drives 68 and 82. The sprocketed drives 68 and 82 also incrementally move the webs 64 and 73, respectively, to and through the transverse aperture 122, in the direction indicated by the arrow 123. As illustrated in FIG. 5A, the sprocketed drive 68 may include dual sprocketed hubs 68h that engage the web 64 and define its path of travel with respect to the planar surface 129. The hubs 68h are mounted on the output shaft of a geared servo motor 68m. The sprocketed hubs 68h engage the sprocket holes 15 and 16 of the web 64. The sprocketed drive 85 that engages the waste web 73wmay be similarly constructed. The sprocketed drive 79 may be constituted of a slip-clutch-driven motor with dual sprocketed hubs (not shown) that starts and stops in precise intervals at precise locations.

With reference to FIGS. 4 and 5A-5E, while traveling together, the webs 64 and 73 are aligned with and pass under a generally U-shaped metal piece (an “indexing foot”) 130 and an anvil 132 received in the space between the legs of the U-shape of the indexing foot 130. The anvil 132 has a footprint substantially equal to or slightly less than that of the strip of substrate material 22 on which an RFID module is supported in the web 73. That is (with reference to FIGS. 1 and 4A), the footprint of the anvil 132 fits within the generally quadrilateral shape of substrate material 22 that is defined between the elongate perforations 29 and 30 and successive transverse perforations 31 where an RFID module is located. The indexing foot 130 swings longitudinally along the web 73, moving with the web 73 in the direction of the arrow 123 as the web 73 advances, and swinging in the opposite direction when the web 73 is halted for assembly of an RFID tag. A welding device 133 is disposed in alignment with and underneath the anvil 132. The anvil 132 reciprocates perpendicularly to the webs 64 and 73, toward and away from the welding device 133, as per the arrow 136. Periodically, the anvil 132 is brought against the web 73, pinching an RFID module on the web 73 and an RFID antenna on the web 64 between itself and the welding device 133. At this point, the welding device 133 is operated to attach the RFID module to the RFID antenna by welding. Preferably, but without limiting the scope of this specification and the claims, the welding device 133 is a sonotrode that ultrasonically welds RFID modules to RFID antennas.

The apparatus 60 assembles RFID tags using sprocketed webs. In an example based upon use of the webs 64 and 73, an RFID tag assembly process may be implemented at a forming station as in the sequence of illustrations in FIGS. 5B-5E. In FIG. 5B, the indexing foot 130 and the anvil 132 are in a “start” configuration with respect to the webs 64 and 73. At the start position, the webs 64 and 73 have been positioned so as to place an RFID antenna against and in alignment with the contacts of an RFID module, with the anvil 132 positioned above and off of the web 73 in alignment with the RFID module. As seen in FIG. 5B, the web 73 transitions to the waste web 73w by way of a sharp turn at 140 around the aligned leading edges of the index foot 130 and anvil 132. This figure shows the waste web 73w as including remnant strips of the web 73 outboard of the perforations 29 and 30. If data verification is used to test the ability of RFID modules to store data before attachment to antennas, the waste web 73w may also include RFID modules that fail the test. One such RFID module is indicated by reference numeral 28f. FIG. 5B also shows separated RFID modules 28s that have been previously attached to underlying RFID antennas (not seen in the figure). In FIG. 5C, a “weld” configuration is illustrated. In the weld configuration, the anvil 132 has been lowered and brought against the web 73, pinching the webs 63 and 74 between itself and the welding device 133. Here, the welding device 133 is energized to attach an RFID module to an underlying RFID antenna (not seen in this figure). In FIG. 5D, a “tear” configuration is illustrated. In the tear configuration, with the anvil 132 still pinching the webs 64 and 73, the index foot 130 swings away from the anvil 132 while the sprocketed drive 85 is energized. Slip-clutch control of the drive 85 keeps the waste web 73w tensioned as indicated by the arrow 131, which causes the strips 23/29 and 24/30 to tear along the elongate perforations 29 and 30, away from the sides of the strip of material 22 on which the just-welded RFID module is carried. In FIG. 5E, a “feed” configuration is illustrated. In the feed configuration, the anvil 132 is lifted, while the sprocketed drive 68 is rotated, moving the product web 88 forward as indicated by the arrow 142, which causes the strip of material 22 on which the just-welded RFID module is carried to tear along the transverse perforation between itself and the next RFID module, thereby wholly separating the module from the web 73. After the product web 88 is moved forward, the anvil 132 is lifted and, as synchronized by cam mechanisms to be described, the product web 68, the index foot 130, the sprocketed drive 82 and the webs 64 and 73 move in the direction of the arrow1 44, far enough forward to bring the index foot 130, the anvil 132, and the webs 64 and 73 into alignment in preparation for assembly of the next RFID tag.

It should be evident that a predetermined relationship between the pitches (spacing) of the sprocket holes and RFID components in the webs 64 and 73 is helpful in ensuring precision of the RFID tag assembly process just described. By way of example, but without limiting the scope of the specification or claims, in one implementation of the assembly process, a sprocketed RFID antenna web 64 and a sprocketed RFID module web 73 as specified in Table I were used in an apparatus according to FIGS. 4 and 5A-5E. The web 64 had sprocket holes spaced at 4 mm intervals and RFID antennas spaced at 12 mm intervals, while the web 73 had sprocket holes at 4 mm intervals and RFID modules at 8 mm intervals. As a result, the web 64 had to be moved 12 mm to advance the next RFID antenna to the welding location while the web 73 had only to be advanced 8 mm. Thus, with reference again to FIG. 5E, the additional 4 mm in movement of the web 73 (and therefore the web 88 ) pulled the just-welded RFID module 4 mm away from the forward edge of the anvil 132, thereby completing the separation of the just-welded RFID module from the waste web 73w, while aligning the next RFID module/antenna pair to be welded.

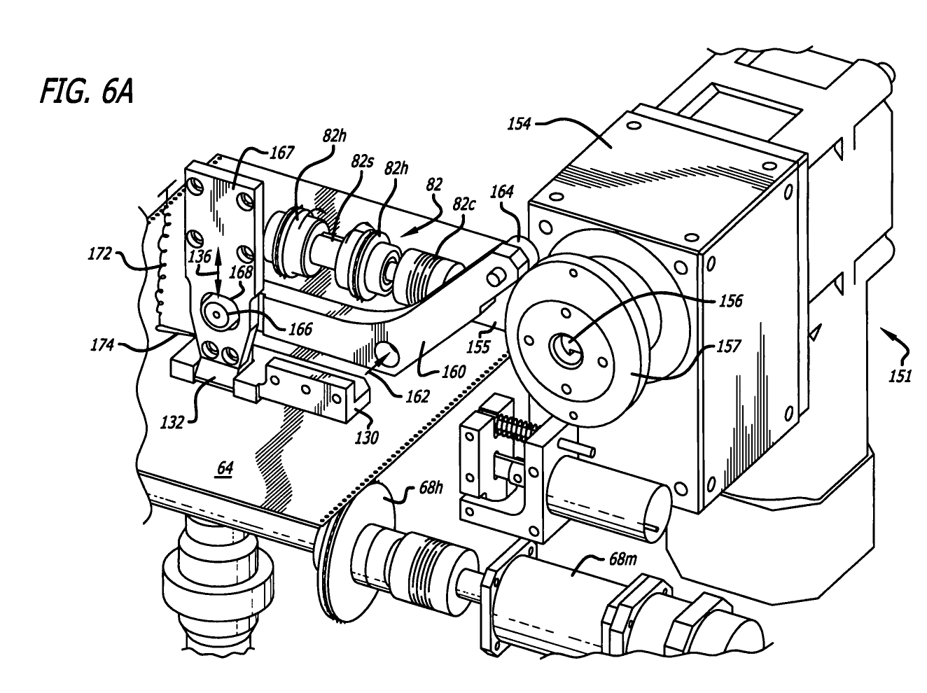

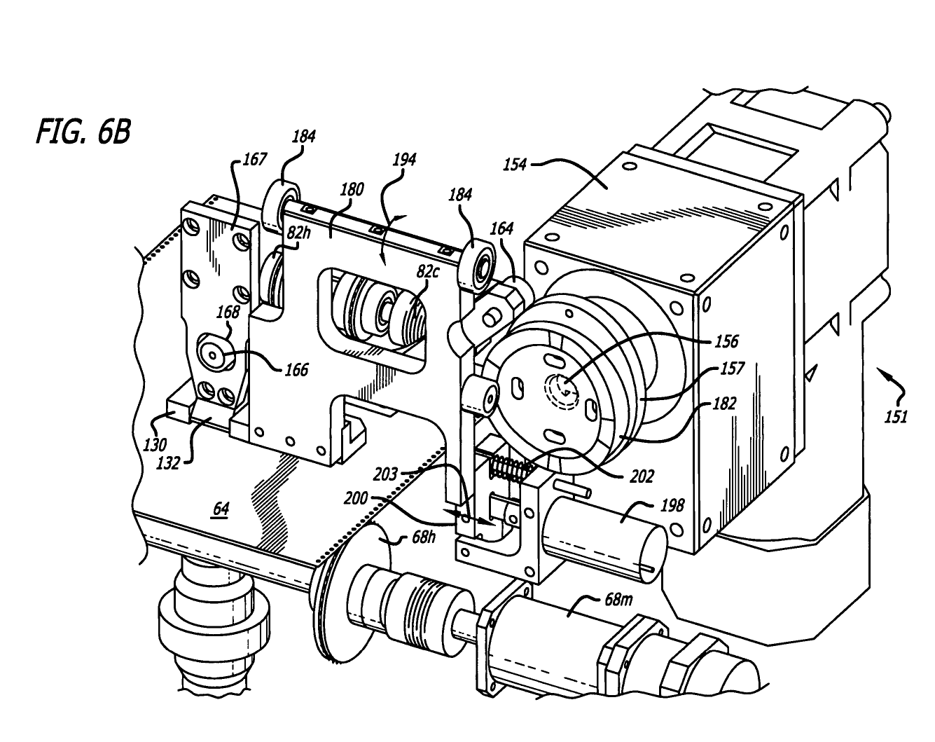

Referring now to FIGS. 5A, 6A and 6B, a preferred operation of the index foot 130 and the anvil 132 in synchronism with movement of the webs 64 and 73 is illustrated. Generally, the perspective of FIGS. 6A and 6B is rotated about 90° clockwise with respect to that of FIG. 5A. In FIG. 6A, an illustrative mechanism for moving the anvil toward and away from the welding device 133 is shown. In this figure, a mechanism for controlling the index foot is removed for clarity, as are the panel 58, the fixed wall 120, and the web 73. A geared motor 150 is connected to the input of an indexing drive 154. The indexing drive 154 provides two outputs: an index drive output 155 that incrementally rotates in precise intervals to precise locations, and a constant rotation output 156 that rotates once with every two intervals of the index drive output 155. Such drives are known and are available, for example, from Sankyo America, Inc. The outputs 155 and 156 cause the sprocketed drive 82 to operate synchronously with the index foot 130 and the anvil 132. The index drive output 155 operates the sprocketed drive 82 which includes spaced-apart sprocketed hubs 82h mounted on a shaft 82s coupled at 82c to the index drive output 155. The constant rotation output 156 has two cams mounted to it; one cam 157 is shown in FIG. 6A. The cam 157 drives an arm 160 that is pivotally mounted at 162 to the fixed wall 120. A cam follower 164 mounted to one end of the arm 160 follows the cam surface on the cam 157. An output ring 166 is mounted to the other end of the arm 160. The anvil 132 is formed on the lower end of an anvil plate 167. The anvil plate 167 has an opening 168 in which the output ring 166 is received. As best seen in FIGS. 5A and 6A, the anvil plate 167 is supported for sliding movement on a sliding block 170 mounted to the fixed wall 120 and is connected to a spring 172 that is stretched between a spring pin 174 on the anvil plate 167 and a spring pin 176 on the fixed wall 120. The cam 157, through the cam follower 164, causes the arm 160 to pivot at 162. As the arm 160 pivots, the output ring 166 reciprocates vertically as per the arrow 136. As it moves upwardly in response to movement of the arm 160, the anvil arm 167 is also pulled by the tension of the spring 172. As it moves downwardly in response to movement of the arm 160, the anvil arm 167 is urged against the tension of the spring 172.

In FIGS. 5A and 6B, an illustrative mechanism for controlling the index foot is shown. The index foot 130 is mounted to an index foot plate 180. A cam 182 is connected to the constant rotation output 156 in front of the cam 157. The cam 182 drives the index foot plate 180, which is pivotally mounted by bearings 184 to a cantilevered support plate 186 mounted on the upper edge of the fixed wall 120. As best seen in FIG. 5A, the sprocketed drive 85 is also mounted to the cantilevered support plate 186. A cam follower 188 mounted to one edge of the index foot plate 180 follows the cam surface on the cam 157. The index foot plate 180 is connected to a spring 190 that is stretched between a spring pin 192 on the index foot plate 180 and a spring pin (not seen) on the fixed wall 120. The cam 182, through the cam follower 188, causes the index foot plate 180 to swing on the bearings 184 toward and away from the fixed wall 120 as indicated by the arrow 194. As the index foot plate 180 swings toward the fixed wall 120, it is also pulled by the tension of the spring 190. As it swings away from the fixed wall 120 in response to rotation of the cam 182, the index foot plate 180 is urged against the tension of the spring 190. A solenoid 198 controls the position of a block 200, acting against a spring 202. Under control of the solenoid 198, the block 200 slides back and forth against the fixed wall 120 as indicated by the arrow 203. In assuming one state, the solenoid 198 slides the block 200 to the position shown, where the block keeps the index foot plate 180 from swinging, which retains the index foot 130 against the anvil 132 even as the cam 182 turns, thereby preventing the RFID module beneath the anvil 132 from being separated from the web 73 and consigning it to the waste web 73w. In assuming the other state, the solenoid 198 slides the block 200 toward itself, permitting the index foot plate 180 to swing, which moves the index foot 130 away from the anvil 132 as the cam 182 turns, thereby permitting the RFID module beneath the anvil 132 to be separated from the web 73 and consigning it, as part of an RFID tag, to the product web 88.

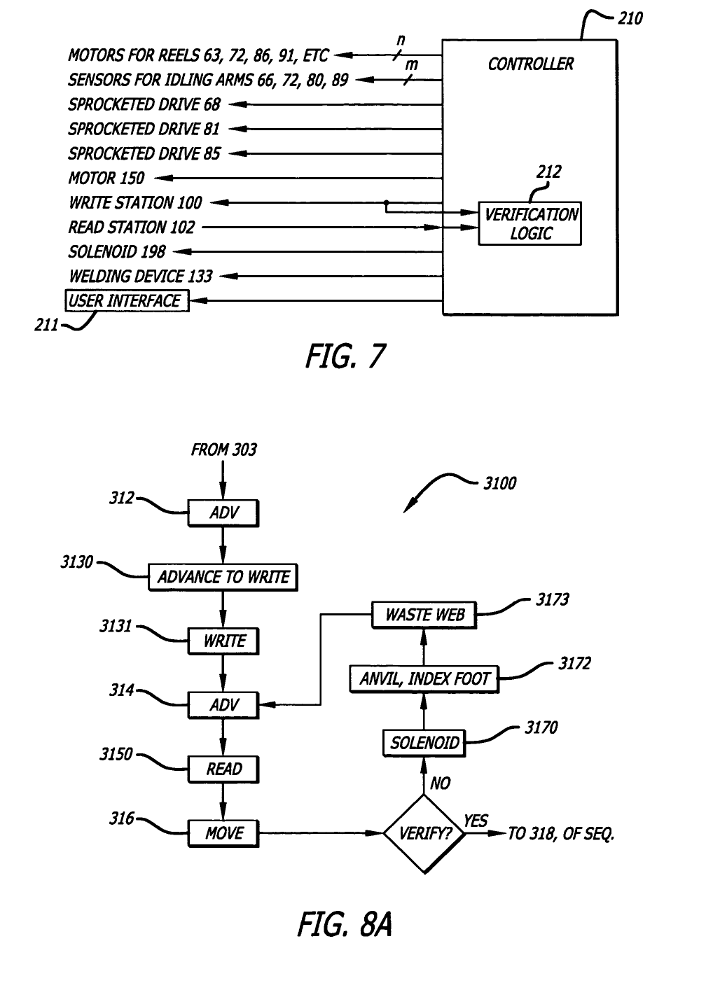

A representative controller for the apparatus 60 may be understood with reference to FIGS. 4, 5B, and 7. Those skilled in the art will appreciate that the precise configuration of the controller to be described, and the way in which it may be connected to the elements that it controls, may be adapted to the particular needs and designs of the applications to which it may be put. In FIG. 7, a controller 210 uses signals from sensors associated with the idling arms 66a, 72a, 80a, and 89a that indicate tension in the webs 64, 73, 73w, and 88, and uses those signals to control the operations of the motors that drive the reels 63, 72, 91, and 86, and, if buffer webs are used, the motors that drive the reels 75 and 95. The controller 210 receives input information and commands via a user interface 211. The input information establishes certain parameter values for control and synchronization of a method by which RFID tags are assembled. Among the parameter values that are set by a user are motor speeds, pitches of the sprocket holes of the antenna and module webs, and the pitches of the RFID antennas and modules on those webs. These and other parameter values enable the controller 210 to provide signals to control the speeds and movements of the sprocketed drives 68, 81, and 85, and to set the speed of the motor 150. Presuming that the controller 210 is invested with control of the write and read stations 100 and 102, control signals are sent to the write station 100 for writing data to RFID modules and signals are received from the read station 102 indicating data read from RFID modules prior to the write station 67. Based on data read from the RFID modules, the controller operates the solenoid 198, causing the forming station 67 to assemble RFID tags by attaching RFID modules to RFID antennas. Data verification logic 212, which may be a component of, or associated with the controller 210, verifies data read from RFID modules. The controller 210 also causes the welding device 133 to weld modules to antennas.

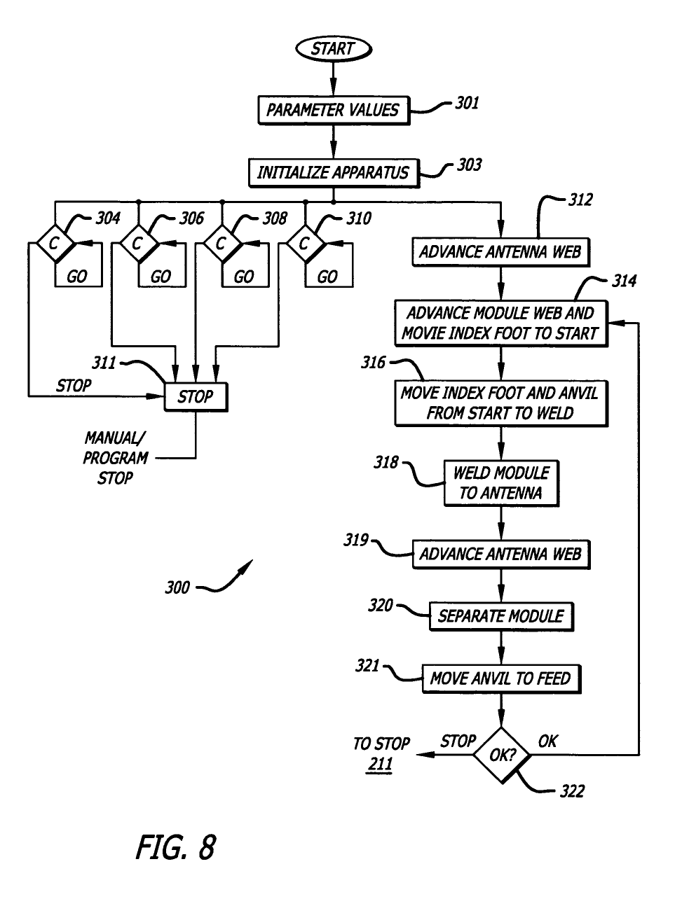

The controller 210 is, preferably, a programmed or a programmable device, or is a specially built unit that executes a series of instructions or a series of operations causing an apparatus such as the apparatus 60 to perform a method for assembling RFID devices such as RFID tags. According to the method, RFID tags are assembled using a web with a sequence of RFID antennas formed thereon and at least another web with a sequence of RFID modules formed thereon. Preferably, the webs are sprocketed webs such as the webs 10 and 20 illustrated in FIG. 1. Such a method may be understood with reference to the method 300 presented in the flow diagram of FIG. 8, which is presented for illustration only.

In FIG. 8, the method 300 starts at 301 by receiving (or retrieving from previously-stored information) input parameter data to set values of control parameters for the apparatus. Among the parameter values that are set are motor speeds, pitches of sprocket holes of the RFID antenna and module webs, and the pitches of the RFID antennas and modules on those webs. For example, with the pitch of sprocket holes and modules on a sprocketed module web, the controller 210 may derive and set an operational speed of the motor 150 which, in turn, will establish the speed with which the index drive 82 feeds the sprocketed module web to and through the forming station 67. With this speed known, the speed with which a sprocketed antenna web is advanced to and past the write station 100 by the sprocketed drive 68 may be set, as may be the motor speeds for the reels 63, 72 and 86. At 303, the apparatus 60 is initialized by mounting all of the reels to the apparatus 60 and threading the sprocketed antenna and module webs through the apparatus as shown in FIG. 4. During initialization at 303, the welding device is not operated and modules in the leading end of the sprocketed module web are left in the waste web. The apparatus then begins to operate.

With further reference to FIG. 8, a method performed by an apparatus to assemble RFID tags using webs, such as sprocketed webs, may be understood. In a control loop (C) 304, the signals from a sensor for the idling arm 66a are used to feed the antenna web into the apparatus 60 by controlling the speed of the motor driving the reel 63. Similarly, in control loops (C) 306, 308, and 310, signals from sensors for the idling arms 72a, 80a, and 89a are used to feed the module web into the apparatus 60, spool the waste web on the reel 86 at the waste station, and spool the product web on the reel 91 at the take-up station, by controlling the speeds of the respective motors driving the reels. In response to tension sensed in a respective web, each of the loops 304, 306, 308 and 310 controls the speed of a motor and tests whether the motor being controlled should cease operating. If the motor should cease operating, the control loop issues a STOP command. Motor-ceasing events that may be indicated by web tension include, for example, and without limitation, web breakage, web jam, completion of web unspooling from the reels 63 and/or 72, completion of web spooling on the reels 86 and/or 91, motor failure, and so on. Any of these or equivalent events will cause the affected loop to transition to 311, which will shut down the web operations of the apparatus 60. Otherwise, the loops 304, 306, 308 and 310 continue their respective operations and set the speeds of their respective reels (GO) for as long as operational requirements are met. The web operations may also be halted at 311 by manual input and/or programmed commands.

Continuing with the description of the method 300 in FIG. 8, while the control loops 304, 306, 308 and 310 operate, the method 300, at 312, advances the antenna web to place an antenna at the forming station 67 by rotating the sprocketed drive 68 by an amount and at a time determined by input parameter values. At the same time, the controller 210 causes the motor 150 to operate at a constant speed determined by input parameter values. At 314, the index drive output 155 of the motor 150 advances the module web a distance calculated to place a module at the forming station 67 by rotating the sprocketed drive 82 an amount equal to the module pitch and at a time as determined by input parameter values. At the same time, at 316, in synchronism with the sprocketed drive 82, the constant rotation output 156 of the motor 150 causes the index foot 130, and the anvil 132 to move through the start configuration of FIG. 5B to the weld configuration of FIG. 5C. As a result of 312, 314, and 316, the antenna and the module on their respective webs are pinched between the anvil 132 and the welding device 133. Now, at 318, the method 300 causes an RFID tag to be assembled by activating the welding device 133 to attach the module to the antenna. At 319, the antenna web is advanced by a distance equal to the antenna pitch. At the same time, at 320, the index foot 130 swings away from the anvil 132 (to the tear configuration of FIG. 5D) and the sprocketed drive 85 is rotated by an amount and at a time determined by input parameter values. Thus, at 320, the method 300 causes the just-attached module to separate from the module web as the waste web is advanced, for example, by advancing the antenna web as the anvil 132 is still held against the just-welded module, while the index foot 130 swings away from the anvil 132. At 321, the method prepares the forming station to assemble the next RFID tag by, for example, raising the anvil 132 as per the feed configuration illustrated in FIG. 5E. Stop conditions may be detected during the method 300 in any one of 312, 314, 316, 318, 319, 320 and 321. For example, and without limitation, such stop conditions may include motor failure, sprocket drive failure, index foot failure, anvil failure, and welding device failure. Of course detection of any stop condition in this portion of the method 300 may cause the method to transition to 311. Such stop conditions are represented in the method at 322, with the understanding that occurrence of any one of these or equivalent events in any one of 312, 314, 316, 318, 319, and 320 will cause a transition to 310, without performance of any succeeding act. Transition to 311 in this portion of the method 300 will shut down the web operations of the apparatus 60. If no stop conditions are detected, the method 300 transitions back to 314 and continues assembling RFID tags.

The method 300 may control the assembly of RFID tags in response to data written into RFID modules. One mode of such control, illustrated by the exemplary method 3100 of FIG. 8A, presumes that write and read stations are provided in the apparatus 60 as described above. The method 3100 is a modification of the method 300 of FIG. 8 and shows only the portion of the method 300 that is modified, the understanding being that the portions omitted from FIG. 8A would nevertheless be included in an implementation of the method 3100. In the method 3100, reference numerals that are common with the method 300 of FIG. 8 denote identical acts. Thus, following 312, the method 3100, at 3130 advances the module web to place one or more modules at the write station 100 by rotating the sprocketed drive 79 by an amount and at a time determined by input parameter values. Then, at 3131, data is written to each of the one or more modules at the write station 100. The data may be the same in each module, or it may differ from module to module. As the module web is advanced at 314, the data in each module is read by the read station 102 at 3150. The data read from each module is verified, for example, by the data verification logic 212, which may be separate from or contained in the controller 210. The data verification logic 212 may be constituted of programming executed by a processor, programmable logic, or special purpose processing circuitry. Verification may be performed according to any number of methods capable of determining if the writing of data to a module has been accomplished accurately. For example, a record of data written to a module may be compared with the data read from the module. One objective of verification is to test for defective modules on the presumption that failure to write data accurately to a module indicates a defective data storage capability of the module. Thus, if the data in a module is verified at 3170, the module may be attached to an antenna on the antenna web by performing 318, 319, 320, and 321, and returning to 314 (assuming no stop conditions). Alternatively, if the data written to a module cannot be verified at 3170, the module may not be attached to an antenna on the antenna web and may be left on the module web as it transitions to the waste web. In this case, with failure to verify data written to a module, when the module has been placed between the anvil 132 and welding device 133 by movement of the module web, the index foot 130 may be blocked, at 3171, from swinging by activation of the solenoid 198 (FIGS. 5A and 5B). The welding device 133 is not activated, and, at 3172, the anvil is cycled from engagement against the module to disengagement from the module. Without movement of the index foot 130 and the antenna web, the module is not separated from the antenna web and, at 3173, is consigned to the waste web, on which it moves toward the waste station as the sprocketed drive 85 is rotated.

Using the apparatus illustrated in FIG. 4, the method of FIG. 8, and sprocketed antenna and module webs as specified in Table I, with antenna pitch at 12 mm and module pitch at 8 mm, RFID tags were assembled at rates in the range from 10,000 to 17,500 RFID tags per hour.

Of course, the control of RFID tag assembly according to FIG. 8A may be performed without steps 3130 and 3131 if data is previously stored in the microchips of the modules before or as the RFID modules are assembled on a module web.

It may be desirable to only write data to the modules, without verification of the data. It may be desirable to write data to the modules with verification performed on the RFID tags of the product web prior to being spooled (at 91 in FIG. 4, for example) in order to detect defective RFID tags and/or to detect the end of a completed product web when the module web is shorter than the antenna web. In either case, data may be verified at a read station provided between a forming station and a product reel (between 67 and 91, for example, in FIG. 4). In the former case, a record of defective RFID tags may accompany the reeled product web so that the defective tags can be identified and discarded as RFID tags are separated from the product web. In the latter case, if the module web is shorter than the antenna web, the product web must be separated from the antenna web where the last RFID tag occurs, and the end of the product web will be where a completed product web as it is later unspooled further processing as, for example, when RFID tags are separated for application to objects. In this case, the method 300 of FIG. 8 could be modified by incorporation of 3130 and 3131 between 312 and 314.

Although the invention has been described with reference to the presently preferred embodiment, it should be understood that various modifications can be made without departing from the spirit of the invention. For example, although the method of assembling modules is preferably performed using sprocketed webs, the method may assemble RFID tags by using webs that are not sprocketed. Accordingly, the invention is limited only by the following claims.

1. A web for assembling radio-frequency identification (RFID) devices using a web manufacturing apparatus, comprising:
an elongate strip of flexible substrate material;
a sequence of RFID components on the strip; and
a sequence of sprocket holes along at least one edge of the strip.

2. The web of claim 1, in which:
the RFID components are RFID modules; and
the strip includes a first elongate perforation between a first side of the strip and the RFID modules and a second elongate perforation between a second side of the strip and the RFID modules;
the strip includes a plurality of transverse perforations interlaced with the RFID modules, each transverse perforation extending between the first and second elongate perforations; and
the strip includes a first sequence of sprocket holes between the first elongate perforation and the first side of the strip and a second sequence of sprocket holes between the second elongate perforation and the second side of the strip.

3. The web of claim 2, in which the flexible substrate material is a polyester film and the RFID modules include contacts constituted of copper deposited on the polyester film.

4. The web of claim 3, in which there is a pitch of 8 mm between the RFID modules and a pitch of 4 mm between the sprocket holes.

5. The web of claim 1, in which:
the RFID components are RFID antennas; and
the strip includes a first sequence of sprocket holes between a first side of the strip and the RFID antennas and a second sequence of sprocket holes between a second side of the strip and the RFID antennas.

6. The web of claim 5, in which the flexible substrate material is a polyester film and the RFID antennas are constituted of copper deposited on the polyester film.

7. The web of claim 6, in which there is a pitch of 12 mm between the RFID antennas and a pitch of 4 mm between the sprocket holes.

8. A web of assembled radio-frequency identification (RFID) devices, comprising:
an elongate strip of flexible substrate material;
a sequence of RFID tags on the strip; and
a sequence of sprocket holes along each edge of the strip.

9. The web of claim 8, in which:
each RFID tag is constituted of an antenna on the flexible substrate material, a module attached to the antenna, and data stored in the module.

10. The web of claim 9, in which the flexible substrate material is a polyester film, each antenna is constituted of copper deposited on the polyester film, and each module is constituted of a microchip with one or more contacts attached to an antenna.

11. The web of claim 10, in which there is a pitch of 12 mm between the antennas and a pitch of 4 mm between the sprocket holes.

12. An apparatus for assembling radio-frequency identification (RFID) devices using a first sprocketed web with a sequence of RFID antennas formed thereon, and at least a second sprocketed web with a sequence of RFID modules formed thereon, comprising:
a first sprocket drive for moving the first sprocketed web on a first path;
a second sprocket drive for moving the second sprocketed drive on a second path;
a write station in the second path for writing data in RFID modules;
a forming station where the first and second paths converge;
a read station in the second path near the forming station for reading data in RFID modules; and,
a controller connected to the read station and to the forming station for causing the forming station to assemble RFID tags by attaching RFID modules to RFID antennas in response to data written in the RFID modules.

13. The apparatus of claim 12, further comprising:
verification logic for verifying data read by the read station; and,
means at the forming station and responsive to the controller for:
separating an RFID module from the second web and attaching the RFID module to an antenna on the first web if the data is verified; or,
leaving an RFID module on the second web while not attaching the RFID module to an antenna on the first web if the data is not verified.

14. The apparatus of claim 13, further comprising:
a waste take-up station for taking up the second web out of the forming station; and
an RFID tag take-up station for reeling the first sprocketed web with RFID tags thereon.

15. An apparatus for assembling radio-frequency identification (RFID) devices, comprising:
a first sprocketed drive for moving a first sprocketed web with a sequence of RFID antennas formed thereon on a first path;
a second sprocketed drive for moving at least a second sprocketed web with a sequence of RFID modules formed thereon on a second path;
a forming station where the first and second paths converge; and,
a controller connected to the forming station for causing the forming station to assemble RFID tags by attaching RFID modules to RFID antennas.

16. The apparatus of claim 15, further comprising:
a write station in the second path for writing data in RFID modules;
a read station in the second path near the forming station for reading data in RFID modules; and,
the controller connected to the read station and including logic responsive to data written in the RFID modules for causing the forming station to assemble RFID tags by attaching RFID modules to RFID antennas.

17. The apparatus of claim 16, wherein the logic is further for verifying data read by the read station, the apparatus further comprising means at the forming station and responsive to the controller for:
separating an RFID module from the second web and attaching the RFID module to an antenna on the first web if the data is verified; or,
leaving an RFID module on the second web while not attaching the RFID module to an antenna on the first web if the data is not verified.

18. The apparatus of claim 17, further comprising:
a waste take-up station for taking up the second web out of the forming station; and
an RFID tag take-up station for reeling the first sprocketed web with RFID tags thereon.

19. The apparatus of claim 15, the forming station including:
a welding device;
an anvil;
an index foot;
an indexing drive coupled to the controller and including an index drive output connected to the second sprocketed drive and a constant rotation drive;
a first cam mounted on the constant rotation drive and engaging the anvil for causing the anvil to move toward and away from the welding device;
and, a second cam mounted on the constant rotation drive and engaging the index foot for causing the index foot to swing toward and away from the anvil.

20. The apparatus of claim 15, further including:
a welding device at the forming station;
means for causing the second sprocketed drive to position RFID modules with respect to RFID antennas at the welding device;
the controller connected to the welding device for causing the welding device to attach RFID modules to RFID antennas; and
means for separating RFID modules attached to RFID antennas from the second sprocketed web.

21. A method for assembling radio-frequency identification (RFID) tags, comprising:
providing a first web with a sequence of RFID antennas thereon on a first path;
providing at least a second web with a sequence of RFID modules thereon on a second path;
reading data in RFID modules in the second path;
attaching RFID modules on the second web to RFID antennas on the first web in response to data written in the RFID modules; and
separating RFID modules attached to RFID antennas from the second web.

22. The method of claim 21, further comprising:
verifying the data read in the RFID modules; and either
separating an RFID module from the second web and attaching the RFID module to an antenna on the first web if the data is verified; or,
leaving an RFID module on the second web while not attaching the RFID module to an antenna on the first web if the data is not verified.

23. The method of claim 21, further comprising writing data in RFID modules in the second path prior to reading data in the RFID modules.

24. The method of claim 23, further comprising taking up the second web following separation of RFID modules from the second web, and reeling the first web with RFID tags thereon.

25. The method of claim 24, wherein the first and second webs are sprocketed webs.
